(19) United States
(12) Patent Application Publication
(10) Pub. No.: US 2022/0004596 A1
(43) Pub. Date: Jan. 6, 2022

(54) Inverse Matrix Calculation Device and Inverse Matrix Calculation Processing Method

(71) Applicant: Nippon Telegraph and Telephone Corporation, Tokyo (JP)

(72) Inventors: Yuki Arikawa, Tokyo (JP); Takeshi Sakamoto, Tokyo (JP)

(21) Appl. No.: 17/296,716

(22) PCT Filed: Nov. 22, 2019
(86) PCT No.: PCT/JP2019/045782

§ 371 Date: May 25, 2021

(30) Foreign Application Priority Data
Dec. 6, 2018 (JP) 2018-228878

(51) Int. Cl. G06F 17/16

(52) U.S. Cl. CPC G06F 17/16; H04B 7/024

(57) ABSTRACT

An embodiment inverse matrix calculation apparatus includes a processor that performs an elementary row operation, based on Gaussian elimination, on an augmented matrix for an input matrix with N rows and N columns, and a memory that stores an N-by-N matrix. The processor stores, each time normalization calculation is performed for an element in an (i+1)-th row and an (i+1)-th column of the augmented matrix, in the memory, an N-by-N matrix having, as an element in a first row and a first column, an element in a first row and an (i+2)-th column of the augmented matrix, repeats, based on the N-by-N matrix stored in the memory, normalization calculation for an element in an (i+2)-th row and the (i+2)-th column of the augmented matrix, and outputs the N-by-N matrix stored in the memory when calculation for first to N-th rows is ended, as an inverse matrix.

This patent application is a national phase filing under section 371 of PCT/JP2019/045782, filed Nov. 22, 2019, which claims the priority of Japanese patent application no. 2018-228878, filed Dec. 6, 2018, each of which is incorporated herein by reference in its entirety.

### TECHNICAL FIELD

The present invention relates to an inverse matrix calculation apparatus and an inverse matrix calculation processing method.

### BACKGROUND

With a widespread use of smartphones, there is an increasing social demand for an increased communication speed, an increased usage bandwidth, and the like in a radio network. In view of such a circumstance, radio network systems to which radio interface specifications of a mobile communication system called Long Term Evolution (LTE) are applied are more often used.

The LTE adopts, as one of radio access technologies, Coordinated Multi-point transmission/reception (CoMP) in which a plurality of transmission points (TPs: base stations) cooperate to transmit and receive a signal to and from a user terminal (UE: user radio terminal) (see NPL 1).

The CoMP technique is an important technique for improving a spectral efficiency and a cell edge user throughput. For example, in downlink communication (transmission from a TP to UEs), if a plurality of transmission points simultaneously use the same frequency band to perform transmission to each of the UEs, it is possible to increase utilization efficiency of a radio resource. However, if each of the plurality of transmission points performs transmission to a different UE, a signal from another transmission point interferes with a desired reception signal for a UE capable of receiving a signal from the plurality of transmission points, and as a result, the throughput may be possibly reduced. Thus, the CoMP is an essential technique for improving the communication speed while suppressing such interference.

Further, research and development on a next-generation mobile communication system evolved from the LTE is pursued, and in a concept expanded from the CoMP, a coordinated radio resource management scheme and a dedicated circuit configuration for increasing a processing speed of such a scheme have been proposed (see NPL 2). In the coordinated radio resource management scheme, it is necessary to perform inverse matrix calculations at least several hundred times in a short time period from sub-milliseconds to one millisecond, and thus, it is essential to increase the processing speed.

Thus, for example, PTL 1 discloses an inverse matrix calculation apparatus for finding an inverse matrix of an nth-order square matrix (n is an integer of 2 or greater) in an n-parallel manner. In the inverse matrix calculation apparatus described in PTL 1, a matrix having a relatively small size is targeted, and a circuit size is n times or greater than a matrix size n.

### CITATION LIST

### Patent Literature

PTL 1: JP 2006-011706 A

### Non Patent Literature

NPL 1: Taoka, et al., “MIMO and inter-cell coordinated transmission and reception technology in LTE-Advanced”, NTT DOCOMO Technical Journal, Vol. 18, No. 2, pp. 22-30, July, 2010 [online]
https://www.nttdocomo.co.jp/binary/pdf/corporate/technology/rd/technical_journal/bn/vol18_2/vol18_2022jp.pdf.
NPL 2: Y. Arikawa, T. Sakamoto and S. Kimura; “Hardware accelerator for coordinated radio-resource scheduling in 5G ultra-high-density distributed antenna systems”, 2017 27th International Telecommunication Networks and Applications Conference (ITNAC), Melbourne, pp. 1-6, November, 2017.

### SUMMARY

### Technical Problem

In the technology disclosed in PTL 1, if a matrix with a relatively large size is processed, the circuit size increases, and even if an FPGA with a relatively large logic scale is employed, calculation resource limitations are imposed, and thus, it is difficult to realize an inverse matrix calculation apparatus.

Embodiments of the present invention have been made to solve the problems described above, and an object thereof is to provide an inverse matrix calculation apparatus capable of processing a matrix with a relatively large size even if calculation resources are limited.

### Means for Solving the Problem

In order to solve the above problems, an inverse matrix calculation apparatus according to embodiments of the present invention is an inverse matrix calculation circuit for receiving, as input, an input matrix being an Nth-order square matrix (N is an integer of 2 or greater) and outputting an inverse matrix of the input matrix, and the inverse matrix calculation apparatus includes a processor that performs, based on Gaussian elimination, processing of an elementary row operation on an augmented matrix in which an Nth-order identity matrix is connected to the input matrix in a row direction and a memory being readable and writable, the memory storing an N-by-N matrix. Each time normalization calculation is performed for an element in an (i+1)-th row and an (i+1)-th column (i=0, 1, . . . , N−1) of the augmented matrix, the processor stores, in the memory, an N-by-N matrix having, as an element in a first row and a first column, an element in a first row and an (i+2)-th column of the augmented matrix after subjected to the normalization calculation, repeats, based on the N-by-N matrix stored in the memory, processing for performing normalization calculation for an element in an (i+2)-th row and the (i+2)-th column of the augmented matrix after subjected to the normalization calculation, and outputs, as the inverse matrix, an N-by-N matrix stored in the memory when normalization calculation for first to N-th rows is ended.

Further, in the inverse matrix calculation apparatus according to embodiments of the present invention, the processor may include a coefficient calculation circuit that multiplies an element in the (i+1)-th row of the augmented matrix by an inverse of a value of an element in an (i+1)-th row and an (i+1)-th column (i=0, 1, . . . , N−1) of the input matrix, which is a diagonal element, to output a first calculation result and a normalization calculation circuit that normalizes the element in the (i+1)-th row of the augmented matrix by using the first calculation result, to output a second calculation result. The processor may write elements included in an area with N rows and N columns having, as an element in a first row and a first column, a first row and an (i+2)-th column included in the second calculation result, into the memory, and update the N-by-N matrix stored in the memory.

Further, in the inverse matrix calculation apparatus according to embodiments of the present invention, the coefficient calculation circuit may include an inverse circuit that evaluates an inverse of a value in an (i+1)-th row and an (i+1)-th column of the input matrix, which is a diagonal element, and a first multiplication circuit that multiplies an element in an (i+1)-th row of the augmented matrix by the inverse. The coefficient calculation circuit may output the first calculation result calculated for every row of the augmented matrix.

Further, in the inverse matrix calculation apparatus according to embodiments of the present invention, the coefficient calculation circuit may be provided with a plurality of the first multiplication circuits to allow for calculation in parallel.

Further, in the inverse matrix calculation apparatus according to embodiments of the present invention, the normalization calculation circuit may include a second multiplication circuit that multiplies the first calculation result by a value of an element in an (i+1)-th column for every row of the input matrix, and a subtraction circuit that subtracts, from a multiplication result by the second multiplication circuit, an element included in a row of the augmented matrix corresponding to a row of the input matrix which is a target of calculation by the second multiplication circuit.

The normalization calculation circuit may repeatedly perform multiplication and subtraction to output the second calculation result for N rows.

Further, in the inverse matrix calculation apparatus according to embodiments of the present invention, the normalization calculation circuit may be provided with a plurality of the second multiplication circuits and a plurality of the subtraction circuits to allow for calculation in parallel.

Further, in the inverse matrix calculation apparatus according to embodiments of the present invention, a plurality of the normalization calculation circuits may be provided to allow for calculation in parallel.

In order to solve the above problems, an inverse matrix calculation processing method according to embodiments of the present invention is an inverse matrix calculation processing method for receiving, as input, an input matrix being an Nth-order square matrix (N is an integer of 2 or greater) and outputting an inverse matrix of the input matrix. The method includes, by a processor that performs, based on Gaussian elimination, processing of an elementary row operation on an augmented matrix in which an Nth-order identity matrix is connected to the input matrix in a row direction, a first step of storing, each time normalization calculation is performed for an element in an (i+1)-th row and an (i+1)-th column (i=0, 1, . . . , N−1) of the augmented matrix, in a memory being readable and writable, an N-by-N matrix having, as an element in a first row and a first column, an element in a first row and an (i+2)-th column of the augmented matrix after subjected to the normalization calculation, a second step of performing, based on the N-by-N matrix stored in the memory in the first step, normalization calculation for an element in an (i+2)-th row and an (i+2)-th column of the augmented matrix after subjected to the normalization calculation, and a third step of repeating the first step and the second step to output, as the inverse matrix, an N-by-N matrix stored in the memory when normalization calculation for first to N-th rows is ended.

### Effects of Embodiments of the Invention

According to embodiments of the present invention, predetermined matrix elements having the same size as an input matrix of an augmented matrix on which an elementary row operation is performed are stored in a memory, and thus, it is possible to process a matrix with a relatively large size even if calculation resources are limited.

### BRIEF DESCRIPTION OF THE DRAWINGS

FIG. 1 is a block diagram illustrating a configuration of an inverse matrix calculation apparatus according to a first embodiment of the present disclosure.

FIG. 2 is a block diagram illustrating a configuration of a coefficient calculation circuit according to the first embodiment.

FIG. 3 is a block diagram illustrating a configuration of a normalization calculation circuit according to the first embodiment.

FIG. 4 is a block diagram illustrating an example of a computer for realizing the inverse matrix calculation apparatus according to the first embodiment.

FIG. 5 is a sample code showing an example of a program executed by the inverse matrix calculation apparatus according to the first embodiment.

FIG. 6 is a flowchart for describing an operation of the inverse matrix calculation apparatus according to the first embodiment.

FIG. 7 is a chart for describing an example of a data structure stored in a memory according to the first embodiment.

FIG. 8 is a block diagram illustrating a configuration of an inverse matrix calculation apparatus according to a second embodiment.

FIG. 9 is a block diagram illustrating a configuration of a normalization calculation circuit according to a third embodiment.

FIG. 10 is a block diagram illustrating a configuration of a coefficient calculation circuit according to a fourth embodiment.

FIG. 11 is a block diagram illustrating a configuration of an inverse matrix calculation apparatus according to an example in the well-known example.

### DETAILED DESCRIPTION OF ILLUSTRATIVE EMBODIMENTS

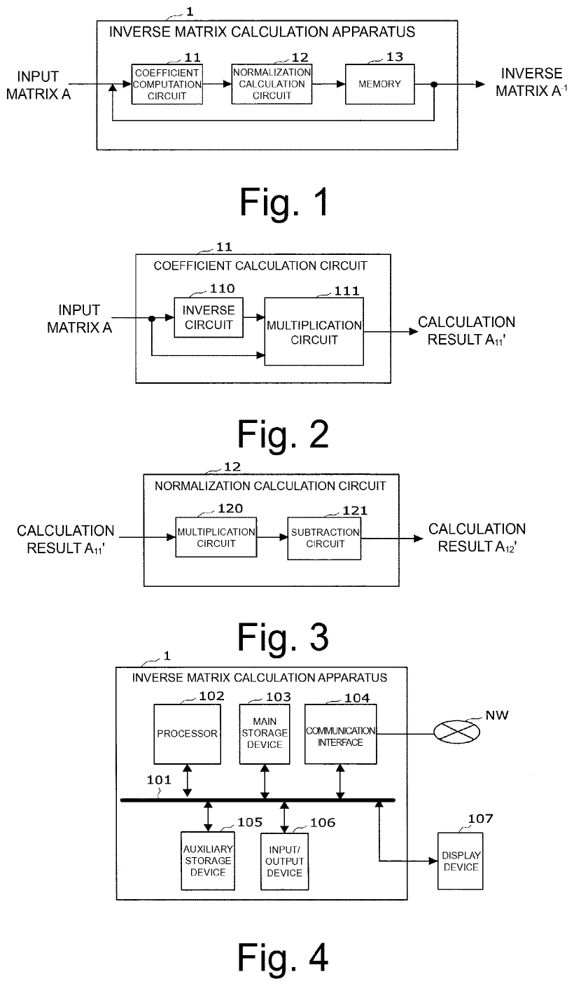

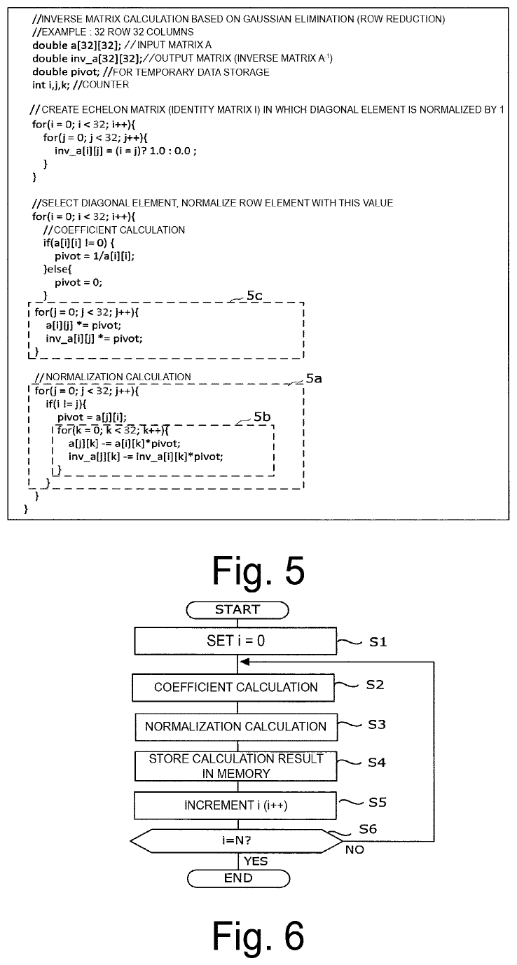

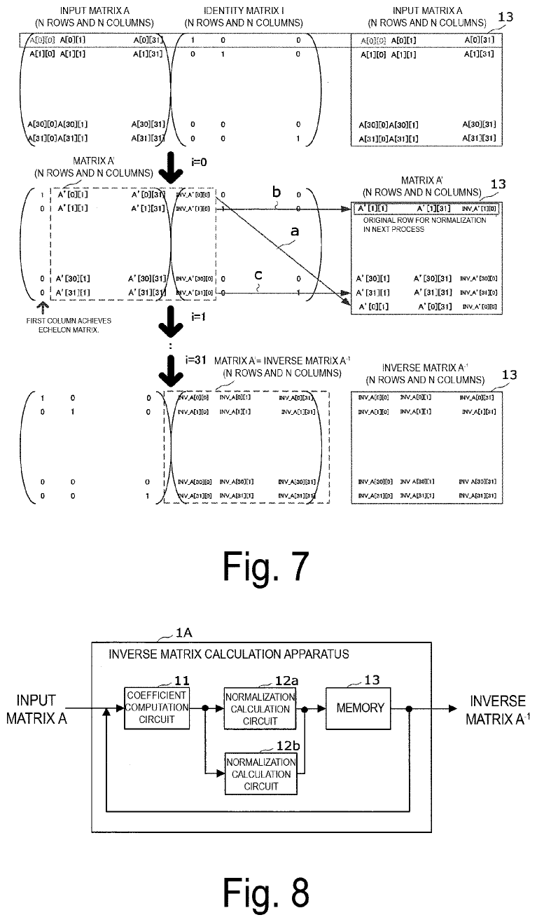

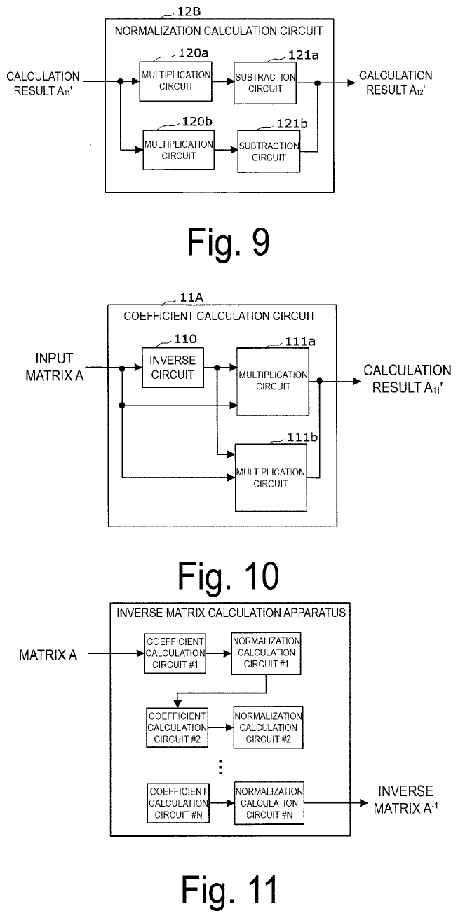

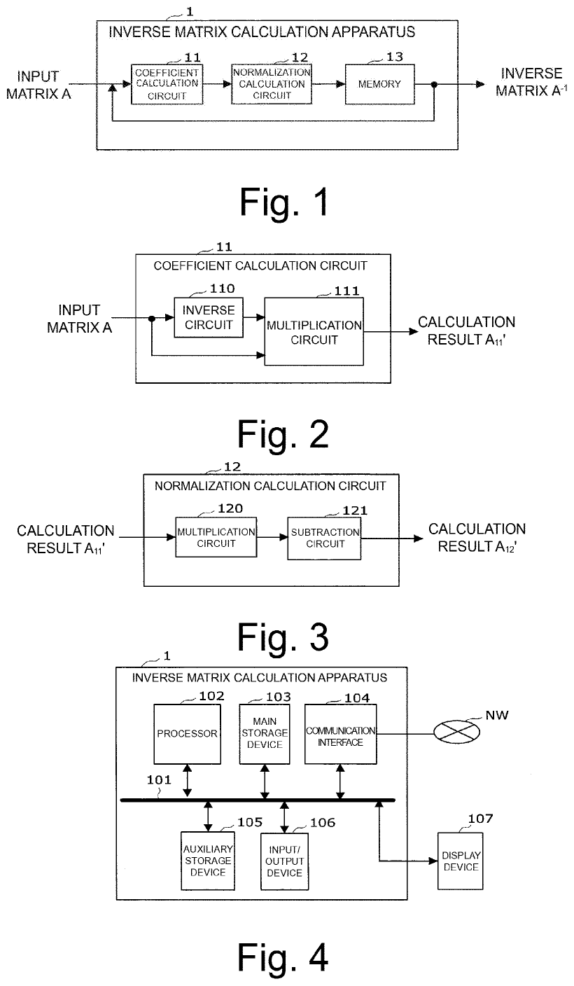

Preferred embodiments of the present invention will be described in detail below with reference to FIGS. 1 to 11.

### SUMMARY OF EMBODIMENTS OF THE INVENTION

First, an inverse matrix calculation apparatus according to an embodiment of the present invention will be outlined. The inverse matrix calculation apparatus receives an input matrix A as input, and calculates and outputs an inverse matrix A⁻¹ of the input matrix A on the basis of well-known Gaussian elimination. Gaussian elimination is also referred to as row reduction. In the present embodiment, the input matrix A is an Nth-order square matrix (N is an integer of 2 or greater), and the inverse matrix A⁻¹ to be output is also an Nth-order square matrix.

Here, when the input matrix A is a regular matrix, the inverse matrix A⁻¹ for the input matrix A exists. When I is an identity matrix with N rows and N columns, a matrix the product of which with the input matrix A is the identity matrix I is the inverse matrix A⁻¹ to be evaluated by the inverse matrix calculation apparatus according to the present embodiment.

In known techniques, in processing for calculating the inverse matrix A⁻¹, two N-by-N matrices, which are the input matrix A and an echelon matrix transformed so as to transform the input matrix A into the identity matrix I, are held in a memory area. On the other hand, in the inverse matrix calculation apparatus according to the present embodiment, according to calculation processing of performing elementary row operations for an augmented matrix (A|I) so that the input matrix A is transformed into the identity matrix I, to evaluate an echelon matrix (a matrix that will finally be the inverse matrix A⁻¹), only elements in a predetermined region with N rows and N columns included in the augmented matrix (A|I) are stored in a memory area.

### First Embodiment

First, a configuration of an inverse matrix calculation apparatus 1 according to a first embodiment of the present invention will be described. As illustrated in FIG. 1, the inverse matrix calculation apparatus 1 includes a coefficient calculation circuit 11, a normalization calculation circuit 12, and a memory 13.

The coefficient calculation circuit 11 evaluates an inverse of a value in the (i+1)-th row and (i+1)-th column (i=0, 1, . . . , N−1) of the input matrix A, which is a diagonal element, multiplies each element in the (i+1)-th row by the evaluated inverse, and outputs an obtained calculation result A₁₁′ (first calculation result).

As illustrated in FIG. 2, the coefficient calculation circuit 11 includes an inverse circuit 110 and a multiplication circuit (first multiplication circuit) 111.

The inverse circuit no evaluates and outputs the inverse of the value in the (i+1)-th row and (i+1)-th column of the input matrix A, which is a diagonal element. The inverse of the value of the diagonal element evaluated by the inverse circuit no is stored in the memory 13 as the value in the (i+1)-th row and (i+1)-th column of the identity matrix I in the augmented matrix (A|I).

The multiplication circuit 111 performs multiplication of each element in the (i+1)-th row of the augmented matrix (A|I) using the inverse of the value in the (i+1)-th row and (i+1)-th column of the input matrix A, which is a diagonal element and calculated by the inverse circuit no, and outputs the calculation result A₁₁′. More specifically, the multiplication circuit 111 reads out elements in the (i+1) rows of the input matrix A stored in the memory 13 in advance, and multiplies each of the elements in the (i+1)-th row of the input matrix A by the inverse.

For example, if i=0, the multiplication circuit 111 reads elements in the first row of the input matrix A stored in advance in the memory 13, and performs calculation for multiplying the first row of the augmented matrix (A|I) by an inverse of an element in the first row and the first column of the input matrix A. If the input matrix A has N rows and N columns, in multiplication for a single row, the multiplication circuit 111 performs a total of N times of multiplication for each of the N elements.

Further, the multiplication circuit 111 performs the multiplication process for each of the N rows, and obtains the calculation result A₁₁′ of the coefficient calculation for each row. For example, the calculation result A₁₁′ includes a multiplication result for each element in a single row of the input matrix A and a value of the inverse evaluated by the inverse circuit 110. The inverse evaluated by the inverse circuit 110 can be used as a value obtained by multiplying the diagonal element of the identity matrix I by the inverse.

Next, the normalization calculation circuit 12 will be described. As illustrated in FIG. 3, the normalization calculation circuit 12 normalizes the element in the (i+1)-th row and (i+1)-th column of the augmented matrix (A|I) by using the calculation result A₁₁′ by the coefficient calculation circuit 11, and outputs a calculation result A₁₂′ (second calculation result).

The normalization calculation circuit 12 includes a multiplication circuit (second multiplication circuit) 120, and a subtraction circuit 121.

The multiplication circuit 120 multiplies the calculation result A₁₁′ by the coefficient calculation circuit 11 by the value of the element in the (i+1)-th column in each row of the input matrix A read from the memory 13.

For example, if i=0, the calculation result A₁₁′ output from the coefficient calculation circuit 11 is values obtained by multiplying each of the elements in the first row of the augmented matrix (A|I) by an inverse of an element in the first row and the first column of the input matrix A. The multiplication circuit 120 multiplies the calculation result A₁₁′ by a value of an element in the second row and the first column of the input matrix A. The multiplication circuit 120 repeatedly performs the same calculation for the third to 32nd (N-th) rows of the augmented matrix (A|I). Thus, when normalization for the element in the first row and the first column is performed, the multiplication circuit 120 performs a total of N−1 times of multiplication (for N−1 rows).

The subtraction circuit 121 subtracts, from the multiplication result by the multiplication circuit 120, each element included in the row of the augmented matrix (A|I) corresponding to the row of the input matrix A which is the target of the calculation by the multiplication circuit 120, and outputs the calculation result A₁₂′.

Specifically, if i=0, the subtraction circuit 121 subtracts each element in the second row of the augmented matrix (A|I) from the result of multiplying the calculation result A₁₁′ in the first row of the augmented matrix (A|I), by the element in the second row and the first column of the input matrix A, that is evaluated by the multiplication circuit 120. The subtraction circuit 121 performs the same calculation for the third to 32nd (N-th) rows of the augmented matrix (A|I).

As described above, once the subtraction circuit 121 has performed the subtraction process for the second to 32nd rows in the case of i=0, processing to achieve an echelon form for the first column of the input matrix A in the augmented matrix (A|I) has been completed. As a result of N−1 times of the subtraction process (for N−1 rows) repeatedly performed by the subtraction circuit 121, the augmented matrix (A|I) including the column for which processing to achieve an echelon form has been completed is obtained as the calculation result A₁₂′.

The memory 13 is a readable and writable memory, and stores the input matrix A with N rows and N columns that is input from outside. More specifically, a memory area depending on the size of the input matrix A is secured in the memory 13, and thus, elements in an area with N rows and N columns can be stored at any time.

Each time the normalization calculation is performed for the element in the (i+1)-th row and (i+1)-th column of the augmented matrix (A|I), a processor 102 described below stores, in the memory 13, an N-by-N matrix having, as an element in the first row and the first column, an element in the first row and the (i+2)-th column of the augmented matrix (A|I) after subjected to the normalization calculation. Further, the processor 102 repeats, based on the N-by-N matrix stored in the memory 13, processing for performing normalization calculation for an element in the (i+2)-th row and (i+2)-th column of the augmented matrix (A|I) after subjected to the normalization calculation.

In particular, the processor 102 previously stores the input matrix A in the memory 13 and keeps on writing the calculation results A₁₁′ and A₁₂′ by the coefficient calculation circuit 11 and the normalization calculation circuit 12 to update the information of the input matrix A.

Specifically, of the calculation result A₁₂′ by the normalization calculation circuit 12, the processor 102 stores, as a matrix A′ having a significant value, elements included in an area with N rows and N columns in the (i+2)-th and subsequent columns after a column of which the input matrix A in the augmented matrix (A|I) is in an echelon form, into the memory 13.

That is to say, when all of the above-described repeated calculations by the coefficient calculation circuit 11 and the normalization calculation circuit 12 are complete, that is, when the elementary row operation for the augmented matrix (A|I) is completed, a desired inverse matrix A⁻¹ having N rows and N columns has been stored in the memory 13.

The processor 102 outputs the N-by-N matrix stored in the memory 13 as the inverse matrix A⁻¹ of the input matrix A when the normalization calculation for the first to N-th rows is completed.

### Computer Configuration of Inverse Matrix Calculation Apparatus

Next, an example of a configuration of a computer for realizing the inverse matrix calculation apparatus 1 having the above-described configuration will be described with reference to FIG. 4.

As illustrated in FIG. 4, the inverse matrix calculation apparatus 1 may be realized by a computer including the processor 102 connected via a bus 101, a main storage device 103, a communication interface 104, an auxiliary storage device 105, an input/output device 106, and a program for controlling these hardware resources, for example. The inverse matrix calculation apparatus 1 may be connected with a display device 107 via the bus 101 to display a calculation result or the like on a display screen, for example.

The main storage device 103 is realized by a semiconductor memory such as SRAM, DRAM, and ROM. The main storage device 103 realizes the memory 13 described in FIG. 1.

The processor 102 controls the memory 13 described in FIG. 1.

A program used by the processor 102 to perform various types of controls and calculations is previously stored in the main storage device 103. Each function of the inverse matrix calculation apparatus 1 including the coefficient calculation circuit 11 and the normalization calculation circuit 12 illustrated in FIGS. 1 to 3 is realized by the processor 102 and the main storage device 103.

The communication interface 104 is an interface circuit for communicating with various external electronic devices via a communication network NW. The inverse matrix calculation apparatus 1 may receive the input matrix A from the outside and send out an obtained inverse matrix A⁻¹ to the outside, via the communication interface 104.

Examples of the communication interface 104 include an arithmetic interface and an antenna that comply with the radio data communication standards such as LTE, 3G, radio LAN, and Bluetooth (registered trademark). The communication network NW includes, for example, Wide Area Network (WAN), Local Area Network (LAN), the Internet, a dedicated line, a radio base station, and a provider.

The auxiliary storage device 105 includes a readable/writable storage medium, and a drive device for reading and writing various information such as a program and data to and from the storage medium. A semiconductor memory such as a hard disk or flash memory which serve as a storage medium can be used as the auxiliary storage device 105.

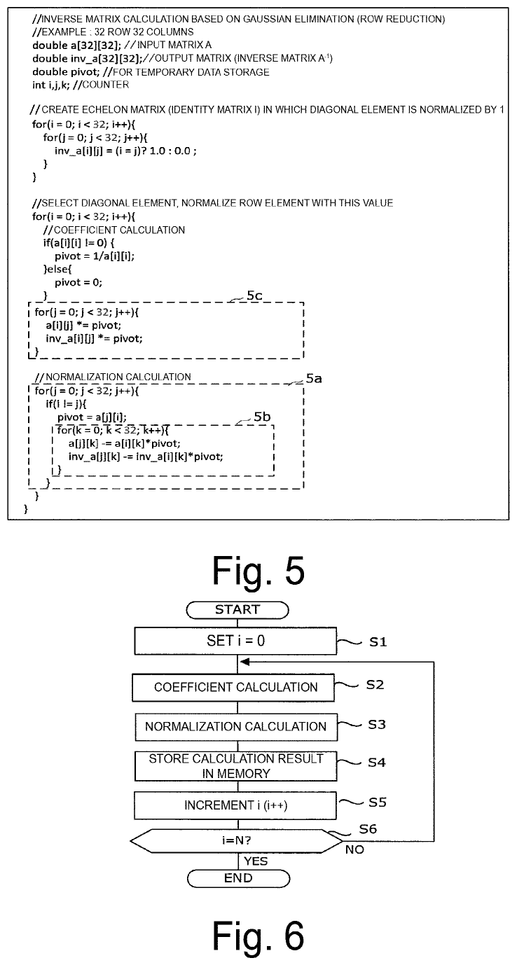

The auxiliary storage device 105 includes a program storage area in which a program used by the inverse matrix calculation apparatus 1 to perform calculation processing for obtaining the inverse matrix A⁻¹ is stored. Further, the auxiliary storage device 105 may include a backup area and the like for backing up the above-described data, programs, and the like. The auxiliary storage device 105 may store an inverse matrix calculation program shown in FIG. 5, for example.

The input/output device 106 includes an I/O terminal that receives a signal from an external device such as the display device 107 and outputs a signal to an external device.

Note that the inverse matrix calculation apparatus 1 may be realized by one single computer and also realized by being distributed over a plurality of computers connected to each other through the communication network NW. The processor 102 may be realized by using hardware such as a field-programmable gate array (FPGA), a large scale integration (LSI), or an application specific integrated circuit (ASIC).

### Operation of Inverse Matrix Calculation Apparatus

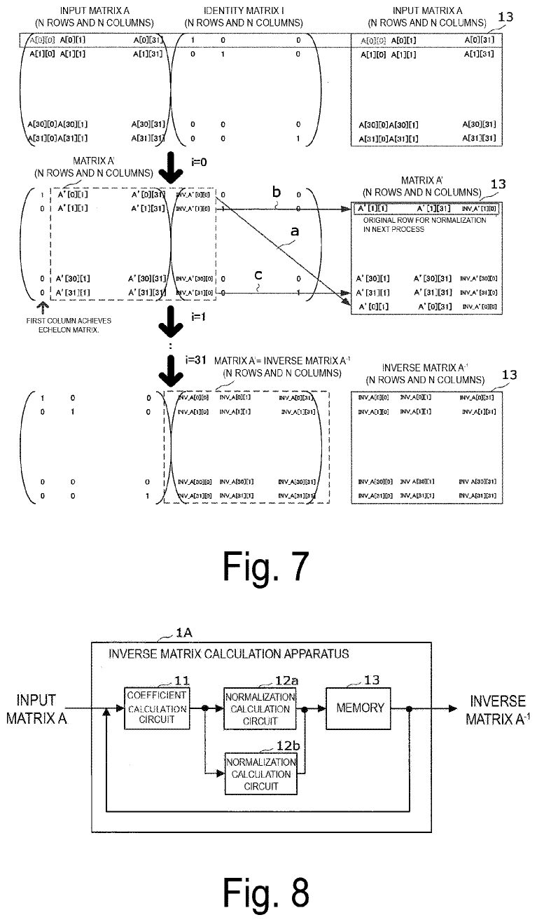

Next, an operation of the inverse matrix calculation apparatus 1 having the configuration described above will be described with reference to FIG. 6 and FIG. 7. Note that the input matrix A with N rows and N columns is input to the inverse matrix calculation apparatus 1 from the outside and previously stored in the memory 13. For example, the memory 13 stores each element of the input matrix A, as shown in a top part of FIG. 7.

Firstly, the processor 102 sets i=0 in the input matrix A with N rows and N columns stored in the memory 13, and selects the (i+1)-th column subject to calculation (step S1). More specifically, the processor 102 selects i=0, that is, the first row of the input matrix A, where the calculation is to be performed, and starts the processing. At this time, the processor 102 generates the augmented matrix (A|I).

Next, the coefficient calculation circuit 11 performs coefficient calculation on the first row of the input matrix A (step S2). More specifically, the inverse circuit 110 reads the input matrix A from the memory 13 and evaluates the inverse of the element in the first row and the first column. The evaluated inverse is input to the multiplication circuit 111, and is multiplied by each element in the first row of the input matrix A. For example, the multiplication circuit 111 performs a total of N times of multiplication.

The coefficient calculation circuit 11 outputs the calculation result A₁₁′ including the multiplication result of the first row of the input matrix A and the inverse of the element in the first row and the first column. The processor 102 reflects the multiplication result of the first row of the input matrix A included in the calculation result A₁₁′, into the first row in the memory 13 shown in the top part of FIG. 7. Note that information on the inverse may be temporarily held in another area of the memory 13.

Thereafter, the normalization calculation circuit 12 normalizes, based on the calculation result A₁₁′ evaluated by the coefficient calculation circuit 11, the element in the (i+1)-th row and (i+1)-th column of the augmented matrix (A|I), that is, the element in the first row and the first column (step S3). Specifically, the multiplication circuit 120 reads each element (calculation result A₁₁′) in the first row of the input matrix A processed through the coefficient calculation in step S2 from the memory 13 to be multiplied by a value of the element in the second row and the first column of the input matrix A.

Thereafter, the subtraction circuit 121 outputs the calculation result A₁₂′ obtained by subtracting each element in the second row from the multiplication result for the first row by the multiplication circuit 120. The multiplication circuit 120 and the subtraction circuit 121 repeatedly perform similar processing, based on the calculation result A₁₁′ of the first row obtained in step S2, for the third to 32nd (N-th) rows, and outputs the calculation result A₁₂′, which is the augmented matrix (A|I) in which the first column of the input matrix A is in an echelon form.

The processor 102 stores a matrix A′ with N rows and N columns included in the calculation result A₁₂′ output from the normalization calculation circuit 12, into the memory 13 (step S4). For example, as shown in a middle part of FIG. 7, the processor 102 writes the matrix A′ including elements included in an area with N rows and N columns having a significant value of the calculation result A₁₂′ by the normalization calculation circuit 12, into the memory 13, and updates the N-by-N matrix stored in the memory 13.

Note that as shown in the middle part of FIG. 7, in an example of the matrix A′ stored in the memory 13, a total of 32 elements (=N elements) including the calculation result A₁₁′ of elements in the first row and the second to 32nd columns of the input matrix A and in the first row and the first column of the identity matrix I are stored in an area corresponding to the Nth row in the memory 13, as indicated with an arrow a. Further, the second row of the input matrix A is stored, as the row to be normalized in the next processing, in an area corresponding to the first row (arrow b), and next thereto, elements in the third and subsequent rows are stored in order (arrow c).

According to the procedure above, the first column of the input matrix A is in an echelon form, and the coefficient calculation and the normalization calculation based on i=0, that is, the element in the first row of the input matrix A, are completed.

Next, the processor 102 increments i (step S5). In the above example, the processor 102 increments i to 1 and selects the (i+1)-th row, that is, the second row, of the input matrix A where the calculation is to be performed.

Thereafter, the processing in step S2 to step S5 is repeatedly executed until i=N−1 is reached (step S6: NO). In the above example, the coefficient calculation circuit 11 reads, from the memory 13, data corresponding to i=1, that is, the second row of the input matrix A to perform the coefficient calculation (step S2). Thereafter, based on the calculation result A₁₁′ by the coefficient calculation circuit 11, the normalization calculation circuit 12 performs normalization calculation so that the second column of the input matrix A is in an echelon form (step S3).

Thereafter, if the second column of the input matrix A has been in an echelon form, the processor 102 stores the matrix A′ including elements included in an area with N rows and N columns including a significant value of the calculation result A₁₂′ of the normalization calculation, into the memory 13 (step S4). More particularly, the processor 102 stores, as the matrix A′, elements included in an area with N rows and N columns in the third and sequent columns of the augmented matrix (A|I) in which the elementary row operation has been performed, into the memory 13.

Thereafter, if calculation up to i=N−1 is performed (step S6: YES), the processing ends, as shown in a bottom part of FIG. 7. For example, if i is incremented to 31 (i=31), the matrix A′ for the N rows and N columns stored in the memory 13 by the processor 102 is a matrix corresponding to the desired inverse matrix A⁻¹. Thus, if the coefficient calculation (step S2) and the normalization calculation (step S3) for the N rows are repeated, the matrix A stored in the memory 13 is finally output as the inverse matrix A⁻¹.

As described above, according to the inverse matrix calculation apparatus 1 of the first embodiment, in the calculation process for outputting the inverse matrix A⁻¹ with the N rows and N columns for the input matrix A with N rows and N columns, based on Gaussian elimination, only the matrix for the N rows and N columns is stored in the memory 13. Thus, in the known technique, an area for holding data in the two N-by-N matrices corresponding to the input matrix A and the identity matrix I is required in a memory; however, the amount of the memory is reduced, and thus, the circuit size may be halved.

In addition, according to the inverse matrix calculation apparatus 1 of the first embodiment, it is possible to reduce a time required for accessing a memory to further increase a speed of the calculation processing including the coefficient calculation processing and the normalization calculation.

Here, in a comparative example with the inverse matrix calculation apparatus 1 according to the present embodiment, FIG. 11 illustrates a configuration of an inverse matrix calculation apparatus in the well-known example, described in PTL 1, for example. In the inverse matrix calculation apparatus in the well-known example illustrated in FIG. 11, the inverse matrix A⁻¹ of the input matrix A being the Nth-order square matrix is evaluated in an N-parallel manner by using N coefficient calculation units and N normalization calculation units.

Such an inverse matrix calculation apparatus in the well-known example targets a matrix having a relatively small size, and has a circuit size of N times or greater than a matrix size N. As such, the inverse matrix calculation apparatus targeting a matrix having a relatively large size may have insufficient resources even if an FPGA having a large logic scale is used.

In contrast, in the inverse matrix calculation apparatus 1 according to the present embodiment, the circuit size is reduced, and thus, it is possible to process a matrix having a relatively large size even if calculation resources are limited.

### Second Embodiment

Next, a second embodiment of the present invention will be described. Note that in the description that follows, the same configurations as those in the above-described first embodiment are denoted by the same reference signs, and descriptions thereof will be omitted.

In the first embodiment, the inverse matrix calculation apparatus 1 including the one normalization calculation circuit 12 is described. On the other hand, an inverse matrix calculation apparatus 1A according to the second embodiment includes a plurality of normalization calculation circuits 12a and 12b, and performs normalization calculation in parallel. For example, in a sample code shown in FIG. 5, normalization calculation indicated by a dashed frame 5a is performed in parallel. A configuration different from that of the first embodiment will mainly be described below.

As illustrated in FIG. 8, the inverse matrix calculation apparatus 1A includes the coefficient calculation circuit 11, the plurality of normalization calculation circuits 12a and 12b, and the memory 13. The inverse matrix calculation apparatus 1A receives the input matrix A with N rows and N columns as input, and outputs the inverse matrix A⁻¹ with the N rows and N columns on the basis of Gaussian elimination.

The inverse matrix calculation apparatus 1A includes M (M is an integer of 2 or greater and N−1 or less, for example) normalization calculation circuits 12a and 12b. The plurality of normalization calculation circuits 12a and 12b are connected in parallel. In an example of FIG. 8, the inverse matrix calculation apparatus 1A includes the two normalization calculation circuits 12a and 12b. Each of the normalization calculation circuits 12a and 12b includes the multiplication circuit 120 and the subtraction circuit 121, as illustrated in FIG. 3.

The normalization calculation circuits 12a and 12b use the calculation result A₁₁′ by the coefficient calculation circuit 11 to normalize an element in the (i+1)-th row and (i+1)-th column of the input matrix A. In the present embodiment, the M normalization calculation circuits 12a and 12b are used to process in parallel the normalization calculation for the N rows. Thus, for example, as illustrated in the example of FIG. 8, if M=2, when each of the normalization calculation circuits 12a and 12b repeats the normalization calculation for (N−1)/2 rows, it is possible to complete the normalization calculation in the input matrix A with N rows and N columns. If M=N−1, the normalization calculation is completed in a single calculation. This is particularly effective if N is 3 or greater.

The processor 102 stores, into the memory 13, the matrix A′ for the N rows and N columns subsequent to the column of which the input matrix A of the augmented matrix (A|I) is in an echelon form, included in the calculation result A₁₂′ output and obtained from each of the normalization calculation circuits 12a and 12b. This updates the N-by-N matrix stored in the memory 13.

Thus, in the inverse matrix calculation apparatus 1A according to the second embodiment, the M normalization calculation circuits 12a and 12b perform the normalization calculation in parallel, and thus, it is not necessary to perform the normalization calculation for the N rows in the input matrix A with N rows and N columns. As a result, the inverse matrix calculation apparatus 1A can increase a speed of the calculation process for evaluating the inverse matrix A⁻¹.

Note that the most appropriate number may be set to the number of M normalization calculation circuits 12a and 12b, for example, in view of the size of the input matrix A, resources of a hardware for use such as FPGA, a desired processing speed, and the like.

### Third Embodiment

Next, a third embodiment of the present invention will be described. Note that in the description that follows, the same configurations as those in the above-described first and second embodiments are denoted by the same reference signs, and descriptions thereof will be omitted.

In the first embodiment, the normalization calculation circuit 12 including the one multiplication circuit 120 and the one subtraction circuit 121 is described. In addition, in the second embodiment, the inverse matrix calculation apparatus 1A including the plurality of normalization calculation circuits 12a and 12b and performing the normalization calculation in parallel, is described.

However, in the inverse matrix calculation apparatus 1 according to the third embodiment, a plurality of multiplication circuits 120a and 120b and subtraction circuits 121a and 121b are provided in one normalization calculation circuit 12B. The inverse matrix calculation apparatus 1 according to the third embodiment performs internal processing of the normalization calculation indicated by a dashed frame 5b in parallel, for example, in the sample code shown in FIG. 5. A configuration other than the above provided in the inverse matrix calculation apparatus 1 according to the third embodiment is in much the same way as in the first embodiment (FIGS. 1, 2, and 4).

The normalization calculation circuit 12B receives the calculation result A₁₁′ by the coefficient calculation circuit 11, performs the normalization calculation in which each element in each row is multiplied and subtracted, and outputs the calculation result A₁₂′. For example, the input matrix A with N rows and N columns has N elements in each row, and N multiplications and subtractions are necessary. The normalization calculation circuit 12B processes the multiplication and subtraction required to perform calculation for each row in parallel, for example.

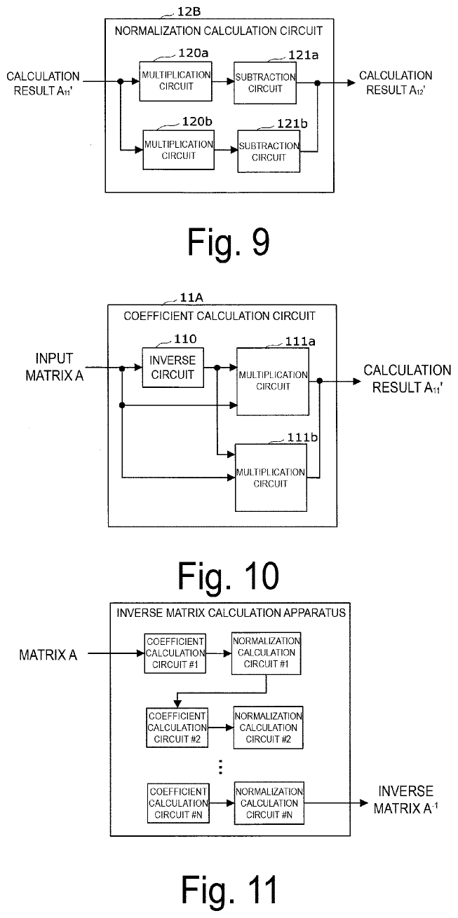

As illustrated in FIG. 9, the normalization calculation circuit 12B includes M (M is an integer of 2 or greater and N or less) multiplication circuits 120a and 120b and subtraction circuits 121a and 121b, where the normalization calculation for one row is performed in an M-parallel manner. Thus, when N/M calculations are repeated, it is possible to obtain a result of the normalization calculation for one row. For example, as illustrated in FIG. 9, if M=2, when N/2 multiplication processing and subtraction processing are repeated, it is possible to complete processing of the normalization calculation for one row. If M=N, the normalization calculation for one row is completed in single multiplication and subtraction processing.

The normalization calculation circuit 12B performs normalization calculation for N rows and outputs the calculation result A₁₂′.

The processor 102 updates the matrix stored in the memory 13 with the matrix A′ with N rows and N columns including a significant value of the calculation result A₁₂′ based on the subtraction result output from each of the subtraction circuits 121a and 121b.

As described above, according to the third embodiment, the normalization calculation circuit 12B processes in parallel the multiplication and the subtraction by the M multiplication circuits 120a and 120b and subtraction circuits 121a and 121b, and thus, it is possible to reduce the number of repeated calculations in the normalization calculation processing for one row. It is possible to further increase a speed of the normalization calculation process for one row to increase a speed of the calculation processing for evaluating the inverse matrix A⁻¹.

Note that the normalization calculation circuit 12B as described above according to the third embodiment may be combined with the M normalization calculation circuits 12a and 12b according to the second embodiment. At this time, the most appropriate number may be set to the number of M multiplication circuits 120a and 120b and subtraction circuits 121a and 121b, for example, in view of the size of the input matrix A, resources of a hardware for use such as FPGA, a desired processing speed, and the like.

### Fourth Embodiment

Next, a fourth embodiment of the present invention will be described. Note that in the description that follows, the same configurations as those in the above-described first to third embodiments are denoted by the same reference signs, and descriptions thereof will be omitted.

In the first embodiment, the coefficient calculation circuit 11 including the inverse circuit 110 and the one multiplication circuit 111 is described. In addition, in the third embodiment, the normalization calculation circuit 12B including the plurality of multiplication circuits 120a and 120b and subtraction circuits 121a and 121b, where the normalization calculation for one row is processed in parallel, is described.

On the other hand, in the fourth embodiment, a coefficient calculation circuit 11A includes a plurality of multiplication circuits 111a and 111b. The inverse matrix calculation apparatus 1 according to the fourth embodiment performs internal processing of the coefficient calculation indicated by a dashed frame 5c in parallel, for example, in the sample code illustrated in FIG. 5. Note that a configuration other than the above provided in the inverse matrix calculation apparatus 1 according to the fourth embodiment is in much the same way as in the first embodiment (FIGS. 1, 3 and 4).

As illustrated in FIG. 10, the coefficient calculation circuit 11A includes the inverse circuit no and M (M is an integer of 2 or greater and N or less) multiplication circuits 111a and 111b.

The inverse circuit no evaluates the inverse of the value of the element in the (i+1)-th row and (i+1)-th column, which is a diagonal element if the input matrix A with N rows and N columns is input, for example.

The multiplication circuits 111a and 111b multiply each element in the (i+1)-th row by the inverse of the diagonal element evaluated by the inverse circuit 110. More specifically, each of the M multiplication circuits 111a and 111b executes in parallel multiplication processing performed on N elements included in the (i+1)-th row of the input matrix A. For example, as illustrated in FIG. 10, if M=2, each of the multiplication circuits 111a and 111b performs N/2 multiplication processing. Thus, if the M multiplication circuits 111a and 111b according to the present embodiment are used to perform the multiplication processing for one row requiring N times of repetitions, the coefficient calculation is performed in an M-parallel manner.

The processor 102 writes the inverse and the multiplication result by each of the multiplication circuits 111a and 111b, as the calculation result A₁₁′, into the memory 13.

Thus, according to the fourth embodiment, the coefficient calculation circuit 11A includes the M multiplication circuits 111a and 111b and performs in parallel the multiplication processing in the coefficient calculation, and thus, it is possible to further increase a speed of the coefficient calculation processing by reducing the number of times of the coefficient calculation for each element in one row.

Further, the inverse matrix calculation apparatus 1 provided with the coefficient calculation circuit 11A according to the fourth embodiment is capable of further increasing a speed of the calculation processing for evaluating the inverse matrix A⁻¹.

Note that the most appropriate number may be set to the number of the M multiplication circuits 111a and 111b, for example, in view of the size of the input matrix A, resources of a hardware for use such as FPGA, a desired processing speed, and the like.

Further, the coefficient calculation circuit 11A according to the fourth embodiment may be combined with the second to third embodiments where appropriate.

Although the embodiments of the inverse matrix calculation apparatus and the inverse matrix calculation processing method according to embodiments of the present invention have been described above, the present invention is not limited to the described embodiments, and various types of modifications that can be conceived by a person skilled in the art can be made within the scope of the invention described in the claims.

For example, a case where the inverse matrix calculation apparatuses according to the above-described embodiments process a matrix where elements are real numbers is described, but a matrix where elements are complex numbers may be processed.

In addition, the inverse matrix calculation apparatuses according to the above-described embodiments may be mounted in a scheduler of a radio network system including a plurality of UEs and antennas and employing a coordinated radio resource management scheme, and may be used as a dedicated accelerator for calculating a system throughput and a transmission weight matrix (see NPL 2). If the inverse matrix calculation circuit according to the present embodiments is employed, it is possible to increase a processing speed in the coordinated radio resource management scheme.

### REFERENCE SIGNS LIST

1 . . . Inverse matrix calculation apparatus
11 . . . Coefficient calculation circuit
12 . . . Normalization calculation circuit
13 . . . Memory
101 . . . Bus
102 . . . Processor
103 . . . Main storage device
104 . . . Communication interface
105 . . . Auxiliary storage device
106 . . . Input/output device
107 . . . Display device
110 . . . Inverse circuit
111, 120 . . . Multiplication Circuit
121 . . . Subtraction circuit
NW . . . Communication network

1.-8. (canceled)

9. An inverse matrix calculation apparatus comprising:
an inverse matrix calculation circuit configured to receive, as an input, an input matrix being an Nth-order square matrix, wherein N is an integer of 2 or greater, and output an inverse matrix of the input matrix;
a processor configured to perform, based on Gaussian elimination, processing of an elementary row operation on an augmented matrix in which an Nth-order identity matrix is connected to the input matrix in a row direction; and
a memory being readable and writable, the memory configured to store an N-by-N matrix,
wherein each time normalization calculation is performed for an element in an (i+1)-th row and an (i+1)-th column (i=0, 1, . . . , N−1) of the augmented matrix, the processor is further configured to:
store, in the memory, an updated N-by-N matrix having, as an element in a first row and a first column, an element in a first row and an (i+2)-th column of the augmented matrix after subjected to the normalization calculation;
repeat, based on the N-by-N matrix stored in the memory, processing for performing normalization calculation for an element in an (i+2)-th row and the (i+2)-th column of the augmented matrix after subjected to the normalization calculation; and
output, as the inverse matrix, the updated N-by-N matrix stored in the memory when normalization calculation for the first to N-th rows is ended.

10. The inverse matrix calculation apparatus according to claim 9, wherein the processor includes:
a coefficient calculation circuit configured to multiply an element in the (i+1)-th row of the augmented matrix by an inverse of a value of an element in an (i+1)-th row and an (i+1)-th column (i=0, 1, . . . , N−1) of the input matrix, which is a diagonal element, to output a first calculation result; and
a normalization calculation circuit configured to normalize the element in the (i+1)-th row of the augmented matrix by using the first calculation result to output a second calculation result,
wherein the processor is configured to write elements included in an area with N rows and N columns having, as an element in a first row and a first column, a first row and an (i+2)-th column included in the second calculation result, into the memory, and update the N-by-N matrix stored in the memory.

11. The inverse matrix calculation apparatus according to claim 10, wherein the coefficient calculation circuit includes:
an inverse circuit configured to evaluate an inverse of a value in an (i+1)-th row and an (i+1)-th column of the input matrix, which is a diagonal element; and
a first multiplication circuit configured to multiply an element in an (i+1)-th row of the augmented matrix by the inverse,
wherein the coefficient calculation circuit is configured to output the first calculation result calculated for every row of the augmented matrix.

12. The inverse matrix calculation apparatus according to claim 11, wherein the coefficient calculation circuit is provided with a plurality of the first multiplication circuits to allow for calculation in parallel.

13. The inverse matrix calculation apparatus according to claim 10, wherein the normalization calculation circuit includes:
a second multiplication circuit configured to multiply the first calculation result by a value of an element in an (i+1)-th column for every row of the input matrix; and
a subtraction circuit configured to subtract, from a multiplication result by the second multiplication circuit, an element included in a row of the augmented matrix corresponding to a row of the input matrix which is a target of calculation by second the multiplication circuit,
wherein the normalization calculation circuit is configured to repeatedly perform multiplication and subtraction to output the second calculation result for N rows.

14. The inverse matrix calculation apparatus according to claim 13, wherein the normalization calculation circuit is provided with a plurality of the second multiplication circuits and a plurality of the subtraction circuits to allow for calculation in parallel.

15. The inverse matrix calculation apparatus according to claim 14, wherein a plurality of the normalization calculation circuits are provided to allow for calculation in parallel.

16. An inverse matrix calculation processing method for receiving, as an input, an input matrix being an Nth-order square matrix, wherein N is an integer of 2 or greater, and outputting an inverse matrix of the input matrix, the method comprising, by a processor configured to perform, based on Gaussian elimination, processing of an elementary row operation on an augmented matrix in which an Nth-order identity matrix is connected to the input matrix in a row direction:
a first step of storing, each time normalization calculation is performed for an element in an (i+1)-th row and an (i+1)-th column (i=0, 1, . . . , N−1) of the augmented matrix, in a memory being readable and writable, an updated N-by-N matrix having, as an element in a first row and a first column, an element in a first row and an (i+2)-th column of the augmented matrix after subjected to the normalization calculation;
a second step of performing, based on the N-by-N matrix stored in the memory in the first step, normalization calculation for an element in an (i+2)-th row and an (i+2)-th column of the augmented matrix after subjected to the normalization calculation; and
a third step of repeating the first step and the second step to output, as the inverse matrix, the updated N-by-N matrix stored in the memory when normalization calculation for the first to N-th rows is ended.
